(19) United States
(12) Patent Application Publication
(10) Pub. No.: US 2024/0033615 A1
(43) Pub. Date: Feb. 1, 2024

(54) IOT-LINKED CASE-CUM-MOBILE GAME PAD

(71) Applicant: Sunwoong LEE, (US)

(72) Inventor: Sunwoong LEE, (US)

(21) Appl. No.: 17/636,713

(22) PCT Filed: Aug. 29, 2019
(86) PCT No.: PCT/KR2019/011064

§ 371 Date: Sep. 7, 2023

(51) Int. Cl. A63F 13/24

(52) U.S. Cl. CPC A63F 13/24; A63F 2300/1043

(57) ABSTRACT

The present invention relates to a mobile game pad. The mobile game pad according to the present invention includes: a body having an accommodation groove corresponding to a mobile phone on the top to be mounted on the mobile phone while surrounding the rear side and the edge of the mobile phone; and a grip unit coupled to the bottom of the body. The grip unit includes: a pack having an internal space; a filler filling the internal space and being able to flow in the internal space; and a separator positioned in the pack and dividing the internal space into two or more spaces. The pack having the internal space filled with the filler has a grip region protruding downward from the body so that user can hold the grip region by hand.

### TECHNICAL FIELD

The present invention relates to a mobile game pad. In more detail, the present invention relates to a mobile game pad accommodating an IoT-linked device such as a mobile phone.

### BACKGROUND ART

Game pads have been used up to now to enjoy games through game systems such as PlayStation and Nintendo.

However, at present, various mobiles games are on the market and it is more popularized to enjoy games using a mobile phone.

In this case, since users have to hold a mobile phone by hand in most cases, there is a problem that a part of the screen is covered by the hand holding the mobile phone, causing inconvenience.

Further, there is a problem that a mobile phone slips out of a hand and is damaged.

In order to solve these problems, a case with a ring that enables a user to easily hold a mobile phone by inserting a finger in the ring has been developed.

However, there is a problem that holding a mobile phone with a finger inserted in the ring also cannot completely remove the inconvenience that users feel when the users have to hold a mobile phone for a long time.

Accordingly, it is required to develop a mobile game pad that can be comfortably used to enjoy games using a mobile phone.

### DISCLOSURE

### Technical Problem

An objective of the present invention is to provide a mobile game pad.

Another objective of the present invention is to provide a mobile game pad that can accommodate a mobile phone, etc. to use them.

Another objective of the present invention is to provide a mobile game pad that can be comfortably held for a long time.

Another objective of the present invention is to provide a mobile game pad that has two grips on a side and another side so that a user can stably hold a mobile phone by holding the grips with both hands.

Another objective of the present invention is to provide a mobile game pad that can provide comfortable feeling of grabbing even though users have various hand shapes and sizes.

Another objective of the present invention is to provide a mobile game pad that has grips that are not excessively deformed or damaged by a separator.

Another objective of the present invention is to provide a mobile game pad that can provide different feelings of grabbing depending on situations through a filler that solidifies in accordance with pressure.

### Technical Solution

The above and other objectives of the present invention may all be achieved by a mobile game pad according to the present invention.

The mobile game pad according to the present invention includes: a body having an accommodation groove corresponding to a mobile phone on the top to be mounted on the mobile phone while surrounding the rear side and the edge of the mobile phone; and a grip unit coupled to the bottom of the body.

The grip unit includes: a pack having an internal space; a filler filling the internal space and being able to flow in the internal space; and a separator positioned in the pack and dividing the internal space into two or more spaces.

The pack having the internal space filled with the filler has a grip region protruding downward from the body so that user can hold the grip region with hand.

The grip region may make an angle of 45° or less with the bottom of the body.

In addition, the pack may have two grip regions protruding from a side and another side of the bottom so that a user can hold the grip regions with both hands, and the separator may be positioned in each of the grip regions.

The separator may divide a space corresponding to the grip region into at least five spaces. In this case, four spaces among the five spaces may be spaces corresponding to each of the user's four fingers except for the thumb and the other one space may be a space corresponding to a palm.

The separator may further have a plate corresponding to a part of the palm under the thumb.

The filler may be a material, which solidifies when pressure is applied and that recovers fluidity when pressure is removed, and may include starch.

### Advantageous Effects

The mobile game pad according to the present invention provides an effect that enables a user to conveniently and stably hold a mobile phone for a long time.

Further, the mobile game pad can provide a comfortable feeling of grabbing even though users have various hand shapes and sizes.

Further, the mobile game pad can provide a feeling of grabbing that is not hard, and can prevent excessive deformation or damage by pressure.

Further, the mobile game pad can provide a feeling of grabbing that is not hard and can provide various feelings of grabbing by solidifying in accordance with positions where force is applied.

### DESCRIPTION OF DRAWINGS

FIG. 1 is a perspective view of a mobile game pad according to an embodiment of the present invention.

FIG. 2 is a view showing the state in which the mobile game pad according to an embodiment of the present invention is used.

FIG. 3 is a side view of the mobile game pad according to an embodiment of the present invention.

FIG. 4 is a view showing an exemplary position of a separator.

FIG. 5 is a view showing another exemplary position of the separator.

FIG. 6 is a perspective view of a mobile game pad according to another embodiment of the present invention.

FIG. 7 is an exemplary view showing a plate.

### BEST MODE

Hereafter, a mobile pad according to the present invention is described in detail with reference to the accompanying drawings.

Only parts needed to understand a mobile game pad according to an embodiment of the present invention are described in the following description and the other parts may not be described not to make the point of the present invention unclear.

The terminologies or words used in the following description and claims should not be construed as being limited to common meanings or the meanings in dictionaries and should be construed as meanings and concepts corresponding to the spirit of the present invention to be able to the most appropriately express the present invention.

Throughout the present specification, unless explicitly described otherwise, “comprising” any components will be understood to imply the inclusion of other components rather than the exclusion of any other components.

In various embodiments, components having the same configuration are given the same reference numerals and described in a representative embodiment, only configurations different from an embodiment is described in other embodiments.

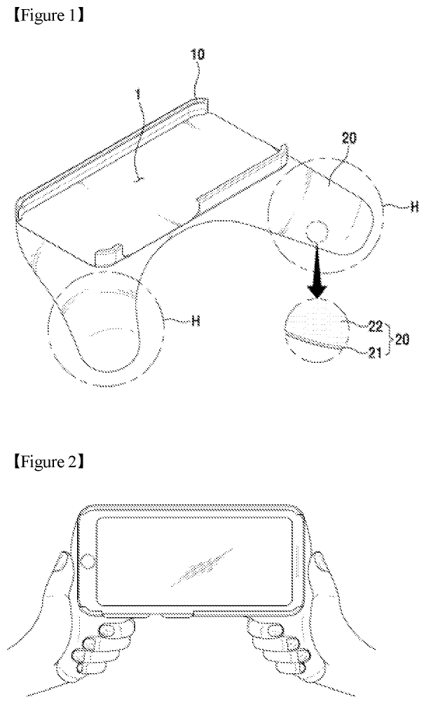

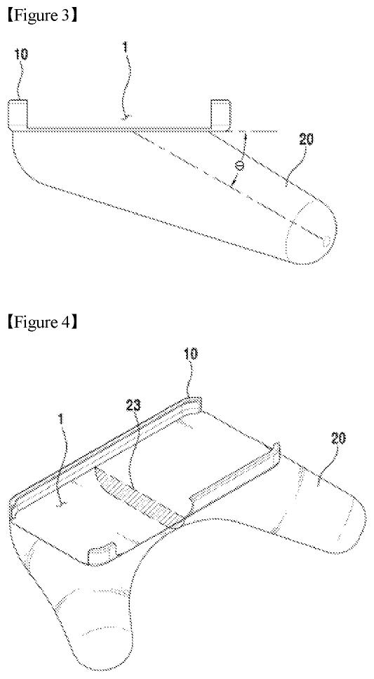

FIG. 1 is a perspective view of a mobile game pad according to an embodiment of the present invention.

As shown in FIG. 1, a mobile game pad according to an embodiment of the present invention includes a body 10 and a grip unit 20.

The body 10 has an accommodation groove 1 corresponding to a mobile phone on the top to be mounted on the mobile phone while surrounding the rear side and the edge of the mobile phone.

The grip unit 20 is coupled to the bottom of the body 10 and has grips for supporting the body and a mobile phone coupled to the body.

The grip unit 20 is a pack 21 filled with a filler 22.

The pack 21 may be configured to have a closed internal space or an internal space closed with the bottom of the body 10.

The pack does not have a fixed shape and may be made of a flexible material such as cloth and vinyl of which the shape is deformed by the pressure of the internal space or pressure from the outside.

The pack has grip regions H partially protruding further than the other region, and when the internal space is filled with a filler, the grip regions may be grips that a user can holds by hand.

A hole (not shown) that can be opened and closed may be formed at the pack so that a filler can be injected into the internal space or the injected filler can be removed out of the pack.

The filler 22 may be a substance that can flow in the internal space of the pack 21, for example, fluid such as liquid, gas, and sol or small solids.

The pack 21 may be shaped when the internal space is filled with the filler. Further, a user can keep hold a mobile phone inserted in the body 10 of the mobile game pad without covering the mobile phone screen by holding the grip regions of the grip unit 20 formed by the pack 21 filled with the filler by hand (see FIG. 2). At this time, it is preferable that the pack has two grip regions H protruding downward from a side and another side of the bottom of the body 10 so that a user can hold the mobile game pad with both hands to stably support a mobile phone.

In addition, it is preferable that the protrusion direction of the grip regions H makes an angle of 45° or less with the bottom of the body 20 so that a user can comfortably see the screen of a mobile phone fitted in the mobile game pad while holding the grip regions by hand.

In addition, since the grip unit 20 is made of a flexible material filled with a filler having fluidity, the filler in the grip regions is moved by the force applied by hands, so it is possible to provide a comfortable feeling of grabbing to all users even though users have various hand shapes and sizes.

However, in order to prevent the problem that when a user excessively strongly holds the grip regions, the filler in the grip regions is excessively pushed to other regions, causing the grip regions to lose the grip function, or the internal pressure of regions of the pack other than the grip regions is excessively increased, causing the pack to be damaged, as shown in FIG. 4, it is preferable that a separator 23 dividing the internal space of the pack into two or more spaces is provided.

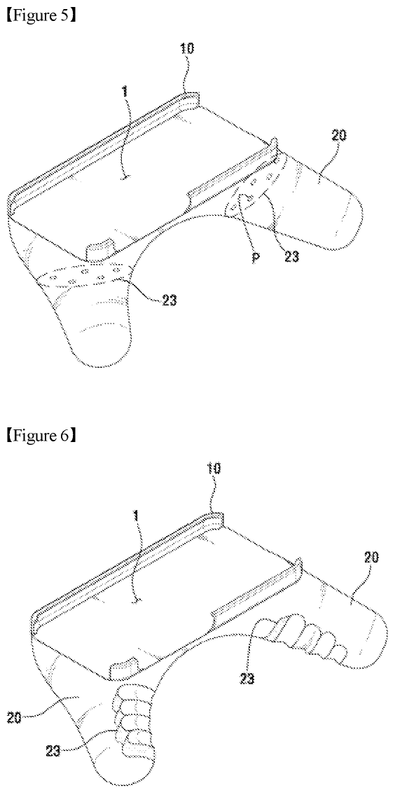

Although an embodiment of a separator 23 dividing the internal space of the pack into two parts is shown in FIG. 4, the separator may be positioned between the grip regions and other regions to separate the grip regions and other regions, as shown in FIG. 5.

Further, since the separator is provided only to prevent free movement of the filler in the internal space of the pack, as shown in FIG. 5, an opening P may be formed at the separator so that the spaces divided by the separator communicate with each other.

FIG. 6 shows a mobile game pad 100′ according to another embodiment of the present invention.

The mobile game pad 100′ according to another embodiment of the present invention shown in FIG. 6 is characterized by being able to provide various feelings of grabbing to users who usually play mobile games, etc.

To this end, a material that solidifies when pressure is applied and that recovers fluidity when pressure is removed is used as the filler 22 of the mobile game pad according to another embodiment of the present invention. Such a filler may be a material containing starch such as a starch solution or starch paste, and the density of the starch is determined such that the starch can solidify by grasping power of a user and can recover fluidity when the grasping power is removed.

The mobile game pad according to another embodiment of the present invention may have a separator to reduce the volume of the internal spaces of the regions in contact with user's hands so that the user can easily solidify the filler. That is, by reducing the volume of the internal spaces of the regions in contact with user's hands, pressure that is enough to solidify the filler can be provided by the grasping power of a user.

In detail, as shown in FIG. 6, in the mobile game pad according to another embodiment of the present invention, the space corresponding to a grip region is divided into at least five spaces by the separator 23.

A user grabs the grip region with four fingers and the palm except for the thumb. Accordingly, four spaces among the five spaces divided by the separator 23 are spaces corresponding to each of four fingers of a user, except for the thumb, and the other one space is a space corresponding to the palm.

A user can feel various feeling of grabbing in accordance with various types of applying force to the fingers when playing games due to the separator dividing the grip region into spaces corresponding to four fingers and another space.

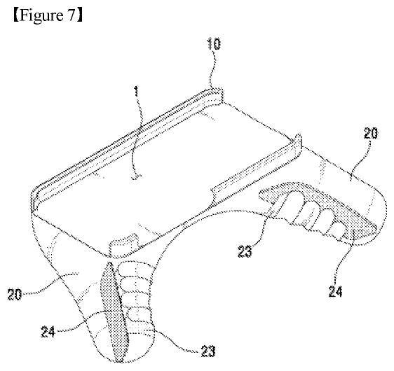

In addition, the separator of the mobile game pad according to another embodiment of the present invention, as shown in FIG. 7, may further include a plate 24 corresponding to the part of the palm under the thumb. The filler in the region corresponding to the part of the palm under the thumb can be more easily solidified by the plate.

Although it was exemplified that a filler that is solidified, depending on pressure, is injected in the pack of the mobile game pad according to another embodiment of the present invention, it may be possible to provide different feelings of grabbing at spaces by injecting different kinds of filler (having different fluidity, texture, density, etc.) in the spaces divided by the separator.

A mobile game pad of the present invention was described above with reference to limitative detailed embodiments. However, the present invention is not limited to the detailed embodiments and it should be understood that the present invention may be changed and modified in various ways without departing from the scope and range of the present invention described in claims.

1. A mobile game pad comprising:
a body having an accommodation groove corresponding to a mobile phone on the top to be mounted on the mobile phone while surrounding the rear side and the edge of the mobile phone; and
a grip unit coupled to the bottom of the body,
wherein the grip unit includes:
a pack having an internal space;
a filler filling the internal space and being able to flow in the internal space; and
a separator positioned in the pack and dividing the internal space into two or more spaces,
wherein the pack having the internal space filled with the filler has a grip region protruding downward from the body so that user can hold the grip region by hand.

2. The mobile game pad of claim 1, wherein the pack has two grip regions protruding from a side and another side of the bottom so that a user can hold the grip regions with both hands, and a protrusion direction of the grip regions makes an angle of or less with the bottom.

3. The mobile game pad of claim 2, wherein the separator separating grip regions and the other region is positioned in the internal space.

4. The mobile game pad of claim 2, wherein the separator divides a space corresponding to the grip region into at least five spaces, and four spaces among the five spaces are spaces corresponding to each of user's four fingers except for the thumb and the other one space is a space corresponding to a palm.

5. The mobile game pad of claim 4, wherein the separator further comprises a plate corresponding to a part of the palm under the thumb.

6. The mobile game pad of any one of claims 1 to 5, wherein the filler is a material, which solidifies when pressure is applied and recovers fluidity when pressure is removed, and includes starch.
